(19) United States
(12) Patent Application Publication
(10) Pub. No.: US 2011/0171394 A1
(43) Pub. Date: Jul. 14, 2011

(54) METHOD OF MAKING A COMBUSTION TURBINE COMPONENT USING THERMALLY SPRAYED TRANSIENT LIQUID PHASE FORMING LAYER

(76) Inventor: David B. Allen, Oviedo, FL (US)

(21) Appl. No.: 12/198,464

(22) Filed: Aug. 26, 2008

(51) Int. Cl. B05D 1/02; B05D 1/36; B05D 3/02

(52) U.S. Cl. 427/452; 427/446; 427/455; 427/456

(57) ABSTRACT

A method of making a combustion turbine component includes thermal spraying a transient liquid phase (TLP) forming layer onto a combustion turbine component substrate and thermal spraying a main material layer onto the TLP forming layer. The combustion turbine component substrate, TLP forming layer, and main material layer are heat treated to thereby bond the main material layer to the combustion turbine component substrate.

### GOVERNMENT CONTRACT

The U.S. Government has a paid-up license in this invention and the right in limited circumstances to require the patent owner to license others on reasonable terms as provided for by the terms of contract No. DE-FC26-05NT42644 awarded by the Department of Energy.

### FIELD OF THE INVENTION

The present invention relates to the field of combustion turbine component fabrication and, more particularly, to methods of making combustion turbine components.

### BACKGROUND OF THE INVENTION

Components for use in the hot section of a combustion turbine are typically produced by the casting of a molten nickel or cobalt-based superalloy into a mold. One or more internal inserts occupy space that will later form internal cooling passages of the combustion turbine component.

One approach at reducing the cost of components formed from such alloys is to bond a pre-made thin skin, or main material layer, to a cast combustion turbine component substrate with cooling passages engraved on its outer surface. The main material layer is either brazed to the combustion component substrate or bonded by a transient liquid phase (TLP) process. Brazing results in a thick bonded region that is substantially different from both the combustion turbine component substrate and the skin. Accordingly, the bond strength may be undesirable.

TLP bonding processes typically involve the placement of a powder, foil, or electroplated TLP forming layer between the combustion turbine component substrate and the main material layer. The TLP forming layer is typically similar in composition to the main material layer, with the addition of one or more melting point depressors. The main material layer, TLP forming layer, and combustion turbine component substrate are then heat treated at a temperature higher than the melting point of the TLP forming layer, but lower than the melting point of the main material layer and combustion turbine component substrate. Accordingly, the TLP forming layer melts during the heating.

As the temperature remains constant, the melting point depressor diffuses from the TLP forming layer into the combustion turbine component substrate and the main material layer, and molecules from the combustion turbine component substrate and the main material layer diffuse into the TLP layer. As a result of this diffusion, the melting point of TLP layer increases beyond the temperature of the heat treatment and the TLP layer, now close in composition to combustion turbine component substrate and the main material layer, resolidifies. The resulting bonded region between the combustion turbine component substrate and the main material layer is thin and of a high strength.

U.S. Pat. No. 6,638,639 to Burke et al., for example, employs such a TLP bonding process to bond a pre-formed alloy skin to a combustion turbine component substrate. A bonding foil comprising a TLP forming alloy is applied as a single sheet of foil across the solid surface of the alloy skin to ensure that the bond foil is applied to regions of the alloy skin that are to be subjected to bonding. The alloy skin and the combustion turbine component substrate are pressed together and heat treated, at a temperature greater than the melting point of the bond foil but less than the melting point of the alloy skin and the combustion turbine component substrate, to form a bond therebetween by the melting and resolidification of the TLP forming alloy of the bonding foil.

U.S. Pat. Pub. No. 2005/0067061 to Huang et al. discloses a method of bonding two metallic workpieces together. A braze slurry containing melting point depressors such, as boron, is placed between the workpieces to be bonded. The workpieces and the slurry are then heat treated to a temperature higher than the melting point of the slurry but lower than the melting point of the workpieces to thereby bond the workpieces together.

U.S. Pat. No. 4,073,639 to Duvall et al. discloses a method of repairing cracks in combustion turbine components. A mix of a powder similar in composition to the combustion turbine component to be repaired and a powder including a melting point depressor is poured into the crack. The combustion turbine component is then heat treated at a temperature greater than the melting point of the TLP forming layer but less than the melting point of the combustion turbine component. A TLP layer forms in the crack, then resolidifies over time, repairing the crack in the combustion turbine component.

The above methods, however, may have a drawback in that they bond a pre-formed alloy skin, or main material layer, to the combustion turbine component substrate. Such a pre-formed alloy skin, or main material layer, may be limited in size and shape. Therefore, new methods of producing alloy skins and bonding such alloy skins to combustion turbine component substrates are desirable.

### SUMMARY OF THE INVENTION

In view of the foregoing background, it is therefore an object of the present invention to provide a method of forming a main material layer and securely bonding it to a combustion turbine component substrate.

This and other objects, features, and advantages in accordance with the present invention are provided by a method of making a combustion turbine component comprising thermally spraying a transient liquid phase (TLP) forming layer onto a combustion turbine component substrate. A main material layer may be thermally sprayed onto the TLP forming layer. The combustion turbine component substrate, TLP forming layer, and main material layer may be heat treated to thereby bond the main material layer to the combustion turbine component substrate. The strength of this bond may be greater than that of a bond formed by a brazing layer, reducing the chance of component failure due to the main material layer delaminating from the combustion turbine component substrate. Likewise, forming the main material layer by thermal spraying allows for larger sizes and more complex shapes than typically available from a pre-formed main material layer.

The melting point depressor may comprise at least one of boron, silicon, tantalum, and manganese. In addition, the TLP forming layer may additionally or alternatively comprise, MCrAlY, with M being selected from the group comprising Fe, Co, Ni, and mixtures thereof, and Y being selected from the group comprising elements other than Fe, Co, Ni, and mixtures thereof.

Thermally spraying the TLP forming layer may comprise thermally spraying a feedstock metallic powder comprising a TLP forming alloy. Likewise, thermally spraying the main material layer onto the TLP forming layer may comprise thermally spraying a feedstock metallic powder comprising a superalloy onto the TLP forming layer.

The main material layer may comprise MCrAlY, with M being selected from the group comprising Fe, Co, Ni, and mixtures thereof, and Y being selected from the group comprising elements other than Fe, Co, Ni, and mixtures thereof. Furthermore, a bond layer may be formed on the main material layer. Additionally, a thermal barrier layer may be formed on the bond layer or on the main material layer.

Another aspect is directed to a method of making a combustion turbine component comprising providing a combustion turbine component substrate that may have cooling passageways thereon which may be filled with a masking material. A transient liquid phase (TLP) forming layer may be thermally sprayed onto the combustion turbine component substrate. A main material layer may be thermally sprayed onto the TLP forming layer. The masking material may be removed from the cooling passageways. The combustion turbine component substrate, TLP forming layer, and main material layer may be heat treated to thereby bond the main material layer to the combustion turbine component substrate.

### BRIEF DESCRIPTION OF THE DRAWINGS

FIG. 1 is a front perspective view of a turbine blade having an alloy coating formed thereon, in accordance the present invention.

FIG. 2 is a greatly enlarged cross sectional view of the turbine blade taken along line 2-2 of FIG. 1.

FIG. 3 is a flowchart of a method in accordance with the present invention.

FIG. 4 is a flowchart of an alternative embodiment of a method in accordance with the present invention.

FIG. 5 is a flowchart of yet another embodiment of a method in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

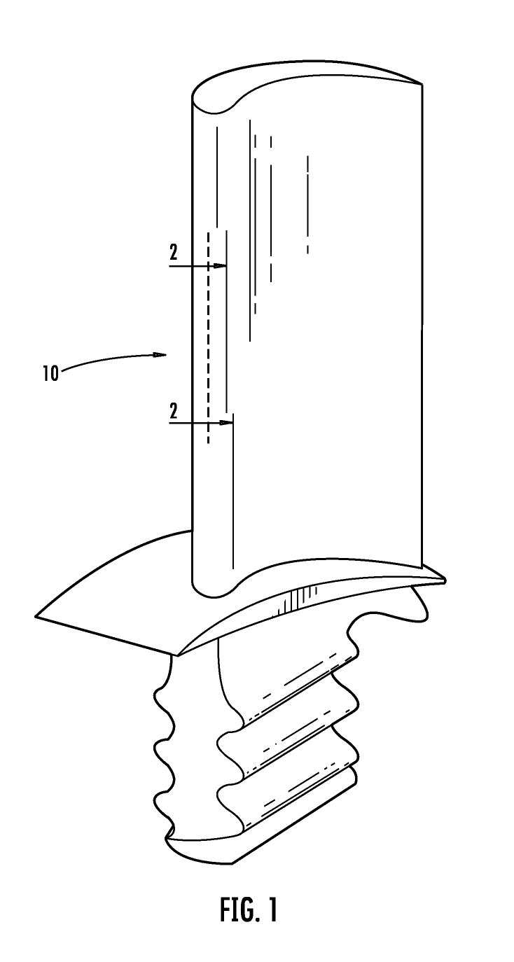

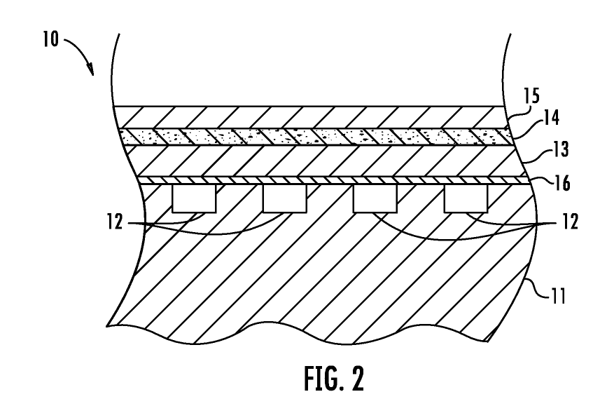

Referring initially to FIGS. 1-2, a turbine blade 10 having an alloy skin (main material layer) 13 formed in accordance with the present invention is now described. The turbine blade 10 comprises a combustion turbine component substrate 11. A main material layer 13 is bonded to the combustion turbine component substrate 11 by vestigial portions of a TLP forming layer 16. Cooling passageways 12 are defined by the surface of the combustion turbine component substrate 11 and the lower surface of the TLP forming layer 16. An optional bond layer 14 is illustratively formed on the main material layer 13. An optional thermal barrier layer 15 is also illustratively formed on the bond layer 14. Those of skill in the art will appreciate that, in some applications, the thermal barrier layer 15 may be formed on the main material layer 13, without an underlying bond layer 14.

It will be readily understood by those of skill in the art that the main material layer 13 discussed above could be bonded to any combustion turbine component, such as a blade or airfoil, by the TLP forming layer 16. The combustion turbine component substrate 11, cooling passageways 12, TLP forming layer 16, main material layer 13, bond layer 14, and thermal barrier layer 15 will be described in detail below.

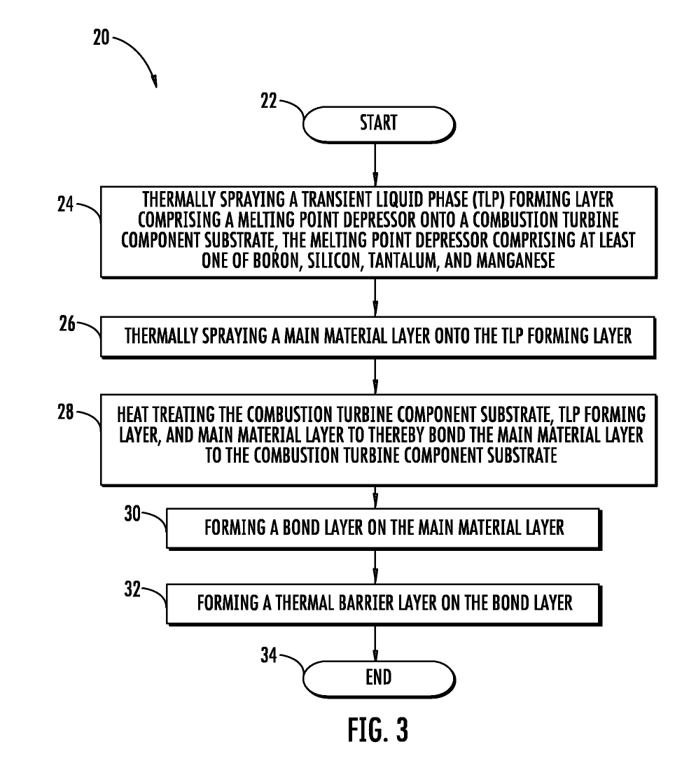

An embodiment of a method of making a combustion turbine component is now described generally with reference to the flowchart 20 of FIG. 3. For clarify of explanation, reference numbers to the structural components described above are not used in the following description. After the start (Block 22), at Block 24 a transient liquid phase (TLP) forming layer comprising a melting point depressor is thermally sprayed onto a combustion turbine component.

The at least one melting point depressor may comprise, for example boron, silicon, tantalum, or manganese, and another metallic compound. In some embodiments, the TLP forming layer may further include MCrAlY, with M being selected from the group comprising Fe, Co, Ni, and mixtures thereof. It is to be understood that the TLP forming layer may comprise other melting point depressors and other metallic compounds.

Some exemplary TLP forming layers include, by percentage of weight,

(1) 15% chromium, 3.5% boron, and a balance of nickel,

(2) 13% chromium, 4% iron, 4.5% silicon, 3% boron, and a balance of nickel,

(3) 11% chromium, 3.5% iron, 3.5% silicon, 2.25% boron, 0.5% carbon, and a balance of nickel,

(4) 7% chromium, 3% iron, 6% tungsten, 4.5% silicon, 3.2% boron, and a balance of nickel, and

(5) 10% chromium, 4% tungsten, 5% cobalt, 4% tantalum, 2% aluminum, 2.6% boron, and a balance of nickel.

It should be noted that a portion of the melting point depressor may be lost in the thermal spraying process and that it may be helpful to increase the percentage of the melting point depressor in some cases.

At Block 26, a main material layer is thermally sprayed onto the TLP forming layer. Thermal spraying of the main material layer allows a wide variety of shapes, thicknesses, and sizes of main material layer to be formed. Moreover, some alloys that may be usable in a thermal spraying process may be unusable in processes that pre-form main material layers (casting, for example).

It is to be understood that any of a number of commercially available thermal spraying process may be employed for thermally spraying the TLP forming layer and the main material layer. For example, plasma spraying, high velocity oxygen fuel (HVOF), cold spraying, or flame spraying may be employed. The TLP forming layer and the main material layer need not be thermally sprayed by the same process, and indeed may be thermally sprayed by different thermal spray processes. The main material layer comprises a superalloy. In particular, the main material layer comprises MCrAlY, with M being selected from the group comprising Fe, Co, Ni, and mixtures thereof. Those of skill in the art will appreciate that the main material layer may comprise other suitable superalloys or alloys. The main material layer may have a single crystal (SX) structure or may have a directionally solidified (DX) structure.

More details of exemplary superalloys from which the main material layer may be formed are found in copending applications COMBUSTION TURBINE COMPONENT HAVING RARE EARTH FeCrAl COATING AND ASSOCIATED METHODS (Attorney Docket No. 62133), COMBUSTION TURBINE COMPONENT HAVING RARE EARTH NiCrAl COATING AND ASSOCIATED METHODS (Attorney Docket No. 62135), COMBUSTION TURBINE COMPONENT HAVING RARE EARTH NiCoCrAl COATING AND ASSOCIATED METHODS (Attorney Docket No. 62136), and COMBUSTION TURBINE COMPONENT HAVING RARE EARTH CoNiCrAl COATING AND ASSOCIATED METHODS (Attorney Docket No. 62137), the entire disclosures of which are incorporated by reference herein. Furthermore, those of skill in the art will readily see that the main material layer may be formed from yet other alloys.

In some applications, it may be advantageous for the TLP forming layer to have a similar composition to the main material layer, with the addition of at least one melting point depressor. In other applications, it may be advantageous for the TLP forming layer to have a similar composition to the combustion turbine component substrate, with the addition of at least one melting point depressor. Further, in yet other applications, it may be advantageous for the TLP forming layer to have a composition dissimilar to both the main material layer and the combustion turbine component substrate.

At Block 28, the combustion turbine component substrate, TLP forming layer, and main material layer are heat treated to thereby bond the main material layer to the combustion turbine component substrate. The heat treating may be performed in a furnace, at a temperature of 1000° C. to 1200° C., for 1 to 24 hours, and at ambient pressure or at elevated pressure. Preferably, the heat treating is performed at a temperature of 1120° C., for 4 hours, and at ambient pressure. The heat treating may be performed in an oxidizing atmosphere or an inert atmosphere, as will be appreciated by those skilled in the art. In addition, the heat treating may even be performed in a vacuum.

During the heat treating, the TLP forming layer will initially melt, while the combustion turbine component substrate and the main material layer remain solid. As the heating continues, the melting point depressor diffuses from the TLP layer into the combustion turbine component substrate and the main material layer, and molecules from the combustion turbine component substrate and the main material layer diffuse into the TLP layer. As a result of this diffusion, the melting point of TLP layer increases beyond the temperature of the heat treatment and the TLP layer, now close in composition to the combustion turbine component substrate and the main material layer, resolidifies. The resulting bonded region between the combustion turbine component substrate and the main material layer is thin, of a high strength, and similar in composition to the surrounding layers.

At Block 30, a bond layer is formed on the main material layer. The bond layer may be formed using techniques and materials known to those skilled in the art. For example, the bond layer may comprise a brazing layer. At Block 32, a thermal barrier layer is formed on the bond layer. The thermal barrier layer is typically made of yttria stabilized zirconia (YSZ) which is desirable for having very low conductivity while remaining stable at nominal operating temperatures typically seen in applications. The bond layer creates a superior bond between the thermal barrier layer and the main material layer, facilitating increased cyclic life while protecting the main material layer and combustion turbine component substrate from thermal oxidation and corrosion. The bond layer and thermal barrier layers are optional.

The thermal barrier layer serves to insulate the combustion turbine component from large and prolonged heat loads by utilizing thermally insulating materials that can sustain an appreciable temperature difference between the load bearing alloys and the main material layer. In doing so, the thermal barrier layer can allow for higher operating temperatures while limiting the thermal exposure of combustion turbine component, extending part life by reducing oxidation and thermal fatigue.

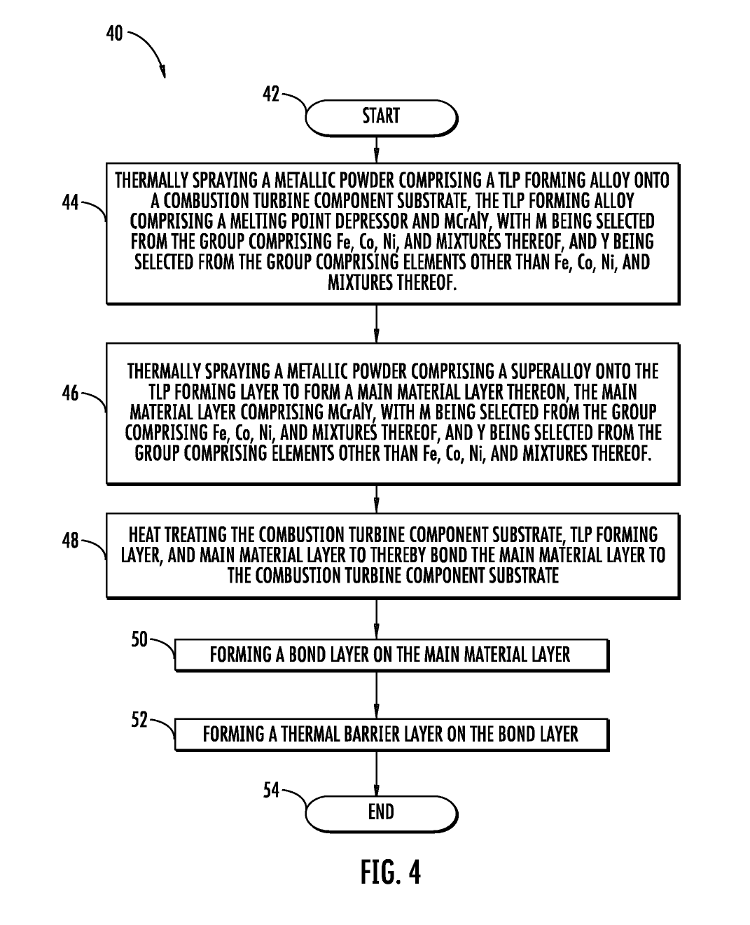

An alternative embodiment of a method of making a combustion turbine component is now described generally with reference to the flowchart 40 of FIG. 4. After the start (Block 42), at Block 44, a feedstock metallic powder comprising a TLP forming alloy is thermally sprayed onto a combustion turbine component substrate, the TLP forming alloy comprising a melting point depressor and MCrAlY, with M being selected from the group comprising Fe, Co, Ni, and mixtures thereof.

At Block 46, a feedstock metallic powder comprising a superalloy is thermally sprayed onto the TLP forming layer to form a main material layer thereon, the main material layer comprising MCrAlY, with M being selected from the group comprising Fe, Co, Ni, and mixtures thereof, and Y being selected from the group comprising elements other than Fe, Co, Ni, and mixtures thereof. Those of skill in the art will appreciate that the main material layer may instead be another aluminium based superalloy or another suitable alloy.

Those of skill in the art will recognize that the feedstock metallic powder comprising a TLP forming alloy and that the feedstock metallic powder comprising a superalloy may be crystalline feedstock metallic powders or amorphous feedstock metallic powders. In addition, they may be of a suitable size, for example nanosized.

At Block 48, the combustion turbine component substrate, TLP forming layer, and main material layer are heat treated to thereby bond the main material layer to the combustion turbine component substrate. At Block 50, a bond layer is formed on the main material layer. At Block 52, a thermal barrier layer is formed on the bond layer.

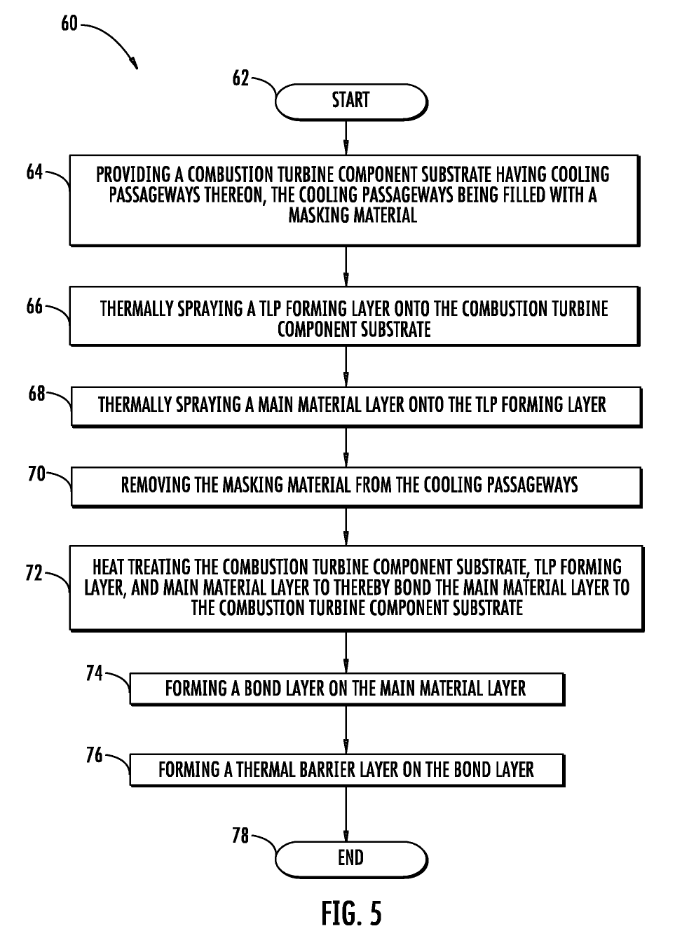

Yet another embodiment of a method of forming a combustion turbine component is now described generally with reference to the flow chart 60 of FIG. 5. After the start (Block 62), at Block 64 a combustion turbine component substrate having cooling passageways thereon is provided. The cooling passageways are filled with a masking material, for example an epoxy. The cooling passageways facilitate the movement of air through the combustion turbine component to achieve a cooling effect, and may be of suitable shapes and sizes known to those skilled in the art. There may be any number of cooling passages, although, in some embodiments, there may be no cooling passages. In some applications, the cooling passages may have one or more open sides, yet, in other applications, the cooling passages may have no open sides.

The combustion turbine component substrate may be cast from a superalloy or other suitable alloy. The cooling passages may be formed by inserts present in the mold during casting, or may be formed after casting by machining.

At Block 66, a TLP forming layer is thermally sprayed onto the combustion turbine component substrate. At Block 68, a main material layer is thermally sprayed onto the TLP forming layer. At Block 70, the masking material is removed from the cooling passageways. The masking material may be dissolved by a solvent, or may be burned away by heat treating, for example at a temperature of 450° C. and for 3.5 hours. Those of skill in the art will appreciate that the masking material may be removed by other processes and that heat treating may be performed at other temperatures and for other periods of time.

At Block 72, the combustion turbine component substrate, TLP forming layer, and main material layer are heat treated to thereby bond the main material layer to the combustion turbine component substrate. At Block 74, a bond layer is formed on the main material layer. At Block 76, a thermal barrier layer is formed on the bond layer.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of making a combustion turbine component comprising:
thermally spraying a transient liquid phase (TLP) forming layer onto a combustion turbine component substrate;
thermally spraying a main material layer onto the TLP forming layer; and
heat treating the combustion turbine component substrate, TLP forming layer, and main material layer to thereby bond the main material layer to the combustion turbine component substrate.

2. The method of claim 1 wherein the TLP forming layer comprises a melting point depressor.

3. The method of claim 2 wherein the melting point depressor comprises at least one of boron, silicon, tantalum, and manganese.

4. The method of claim 1 wherein the TLP forming layer comprises MCrAlY, with M being selected from the group comprising Fe, Co, Ni, and mixtures thereof.

5. The method of claim 1 wherein thermally spraying the TLP forming layer comprises thermally spraying a feedstock metallic powder comprising a TLP forming alloy.

6. The method of claim 1 wherein thermally spraying the main material layer onto the TLP forming layer comprises thermally spraying a feedstock metallic powder comprising a superalloy onto the TLP forming layer.

7. The method of claim 1 wherein the main material layer comprises an aluminium based superalloy.

8. The method of claim 1 further comprising forming a bond layer on the main material layer.

9. The method of claim 1 further comprising forming a thermal barrier layer on the main material layer.

10. A method of making a combustion turbine component comprising:
providing a combustion turbine component substrate having cooling passageways thereon, the cooling passageways being filled with a masking material;
thermally spraying a transient liquid phase (TLP) forming layer onto the combustion turbine component substrate;
thermally spraying a main material layer onto the TLP forming layer;
removing the masking material from the cooling passageways.
heat treating the combustion turbine component substrate, TLP forming layer, and main material layer to thereby bond the main material layer to the combustion turbine component substrate; and

11. The method of claim 10 wherein the TLP forming layer comprises a melting point depressor.

12. The method of claim 11 wherein the melting point depressor comprises at least one of boron, silicon, tantalum, and manganese.

13. The method of claim 10 wherein the TLP forming layer further comprises MCrAlY, with M being selected from the group comprising Fe, Co, Ni, and mixtures thereof.

14. The method of claim 10 wherein the main material layer comprises aluminium based superalloy.

15. A method of making a combustion turbine component comprising:
thermally spraying a transient liquid phase (TLP) forming layer comprising a melting point depressor onto a combustion turbine component substrate;
thermally spraying a main material layer comprising an aluminum based superalloy onto the TLP forming layer, with M being selected from the group comprising Fe, Co, Ni, and mixtures thereof; and
heat treating the combustion turbine component substrate, TLP forming layer, and main material layer to thereby bond the main material layer to the combustion turbine component substrate.

16. The method of claim 15 wherein the melting point depressor comprises at least one of boron, silicon, tantalum, and manganese.

17. The method of claim 16 wherein the TLP forming layer further comprises MCrAlY, with M being selected from the group comprising Fe, Co, Ni, and mixtures thereof.

18. The method of claim 15 further comprising forming a bond layer on the main material layer.

19. The method of claim 15 further comprising forming a thermal barrier layer on the main material layer.

20. The method of claim 15 wherein thermally spraying the TLP forming layer comprises thermally spraying a feedstock metallic powder comprising a TLP forming alloy; and wherein thermally spraying the main material layer onto the TLP forming layer comprises thermally spraying a feedstock metallic powder comprising a superalloy onto the TLP forming layer.
